(19) United States
(12) Patent Application Publication
(10) Pub. No.: US 2011/0234091 A1
(43) Pub. Date: Sep. 29, 2011

(54) NON-EVAPORABLE GETTER FOR FIELD-EMISSION DISPLAY

(75) Inventors: Tadayuki Yoshitake, Tokyo (JP); Takuto Moriguchi, Chigasaki-shi (JP); Yoichi Ando, Inagi-shi (JP)

(73) Assignee: CANON KABUSHIKI KAISHA, Tokyo (JP)

(21) Appl. No.: 13/046,948

(22) Filed: Mar. 14, 2011

(30) Foreign Application Priority Data
Mar. 26, 2010 (JP) 2010-072952

(51) Int. Cl. H01J 17/24; B05D 1/36; B32B 15/04

(52) U.S. Cl. 313/554; 427/205; 428/661

(57) ABSTRACT

The present invention provides a non-evaporable getter for an FED which can remove a plurality of types of gases. The non-evaporable getter for the FED has a first layer containing titanium, and a second layer containing crystalline zirconium layered on the first layer. The average value of crystalline grain sizes of the crystalline zirconium is 3 nm or more but 20 nm or less.

### BACKGROUND OF THE INVENTION

1. Field of the Invention

The present invention relates to a non-evaporable getter for a field-emission display, which can absorb a gas, and a manufacturing method therefor.

2. Related Background Art

In recent years, an image area of an image display apparatus has progressively become larger. Conventionally, a cathode ray tube (Cathode Ray Tube: hereafter referred to as CRT) has been most popularly used as the image display apparatus. However, there is a problem that the CRT is large and heavy, and a light thin tabular image display apparatus which is so-called a flat panel display (Flat Panel Display: hereafter referred to as FPD) has received attention as a substitute for the CRT.

In these years, the FPD has been actively researched and developed, and FPDs based on various principles such as a liquid crystal display device, a plasma display and an organic EL have been developed. As one of such field-emission displays, there is a field-emission display (Field Emission Display: hereafter referred to as FED).

Although the FED is a display which makes a fluorophor emit light by using an electron beam similarly to CRT, the FED is different from the CRT and has a structure of having arranged many electron sources therein which emit electrons by a force of an electric field while using a cold cathode. One example of the FED includes a display which has the surface conduction electron-emitting device arranged on a glass substrate in a matrix form. This display is referred to as a surface conduction electron-emitting device display (Surface-Conduction Electron Emitter Display: SED).

The FED needs to keep the inner part of a container (envelope) at a high vacuum, similarly to the CRT. This is because if the pressure in the container increases, there arise such problems that the performance of the electron source degrades due to gas, the electron source is destroyed by an ionized gas, and the electron source and the container are destroyed by electric discharge.

In order to obtain an airtight container of a high vacuum, such a method is employed as to heat the inner part of the container while exhausting gas, desorb the gas which has been absorbed by the inner surface of the container, and hermetically seal the container. However, it is difficult to sufficiently remove remaining gases in the container only by this method, and it is impossible to remove the desorption gas which is formed when elements in the container have been driven after the container has been sealed. For this reason, such a method is employed as to arrange a metal thin film which is referred to as a getter in the inner part of the container, and makes the getter physically and chemically absorb the gas in the container, as a method of keeping the degree of the vacuum in the container at a high level after the container has been sealed.

The getters are largely classified into two types which are an “evaporable getter” and a “non-evaporable getter (Non-Evaporable Getter: hereafter referred to as NEG)”.

The evaporable getter is a getter in which a metal film that has been vapor-deposited on the inner surface of the container in a vacuum is used in the state as a pump. There is barium (Ba) as a typical material of the evaporable getter. The evaporable getter has a feature of showing a pump function immediately after the getter has been vapor-deposited. On the other hand, because the getter cannot be exposed to the atmosphere after having been vapor-deposited once, it is necessary to consistently perform steps from the vapor deposition of the getter to the sealing of the container, in a vacuum.

On the other hand, the non-evaporable getter is formed from a metal such as titanium (Ti), zirconium (Zr) and vanadium (V), or an alloy containing the above metal as a main component, and is formed on the inner surface of the container with a vapor-deposition technique, a sputtering technique or the like. When the non-evaporable getter is heated in a vacuum or under an atmosphere of an inert gas or the like, an oxide film which exists on the surface thereof diffuses into the inner part, and a clean metal surface is exposed to the outermost surface. Thereby, the remaining gas in the vacuum is absorbed by the non-evaporable getter. This heating process is referred to as “activation.” As is clear from the absorption principle, the non-evaporable getter shows an absorption capability again by being subjected to the activation process, even when the oxide film or the like is formed on the surface thereof. Accordingly, the non-evaporable getter can be exposed to the atmosphere, or can be subjected to a working process such as photolithography after the non-evaporable getter has been formed.

This feature enables the non-evaporable getter to be formed with a process similar to that of forming the electron source before the electron source of the FED is formed or while the electron source is formed, and accordingly has the advantage of being capable of reducing a manufacturing cost. Therefore, the non-evaporable getter can be used as a getter which keeps the envelope of the FED at a vacuum.

In addition, because the FED has a structure in which the electron sources are arranged in a flat form in a thin vacuum airtight container, the FED is required to suppress the increase in a local pressure. Accordingly, it is desirable for the getter to be formed in the vicinity of the electron source, and from this viewpoint as well, the non-evaporable getter which is easy to be fine-processed by using a processing technology such as the photolithography can be used.

Various gases exist in the inner part of the container which constitutes the FED, which include a gas that has contaminated when the FED has been sealed, a desorption gas formed from an internal member, a desorption gas formed by the drive of the electron source or the like. In order to appropriately suppress the influence of the gas to the electron source, it is necessary to remove all of these gases until the partial pressure reaches a tolerance or less of the electron source.

Here, because a gas-desorption rate (rate of gas generation) varies depending on a type of gas, the getter is required to have different absorbing performances depending on the types of gas. For instance, in the case of the FED, the gas-desorption rate of H₂O gas (water vapor) is large in an early stage of the drive of the electron source, but rapidly decreases after that. For this reason, the getter needs a large absorbing speed for the H₂O gas in the early stage of the drive, but does not need to keep the large absorbing speed over a long period of time. In the case of CO gas (carbon monoxide), the getter does not need a large absorbing speed because the gas-desorption rate in the early stage of the drive of the electron source is small, but is required to keep the absorbing speed over a long period of time, because the gas-desorption rate hardly decreases after that.

On the other hand, the getter film shows different absorbing performances for the types of gas depending on its composition metal or an alloy thereof. For instance, a non-evaporable getter containing Zr as a main component has a high absorption capability for H₂O gas, and has a sufficient performance for the H₂O gas as a getter for an FED. However, the non-evaporable getter shows low absorption capability for CO gas, and as for the CO gas, the absorption capability is insufficient for the stable drive of the FED. In addition, a non-evaporable getter containing Ti as a main component has a sufficiently high absorption capability for the CO gas, but has an insufficient absorption capability for the H₂O gas.

Thus, the FED has a problem that it is difficult to sufficiently remove the gases in the inner part of the container of the FED by a getter formed of a film having a single composition, because a plurality of gases which should be removed out from the container exist therein.

### SUMMARY OF THE INVENTION

An object of the present application is to provide a non-evaporable getter suitable for removing plural types of desorption gas and remaining gas from the container constituting the FED. Particularly, one object of the present application is to provide a non-evaporable getter which shows a high absorbing speed for H₂O gas in the early stage of activation, and keeps an absorbing speed for CO gas for a long period of time. The present invention also includes a method for manufacturing such a non-evaporable getter and an FED provided with the non-evaporable getter, in its scope.

According to the one aspect of the present invention, the present invention provides a non-evaporable getter for a field-emission display comprising: a first layer containing titanium; and a second layer containing crystalline zirconium layered on the first layer, wherein an average value of crystalline grain sizes of the crystalline zirconium is 3-20 nm.

According to a further aspect of the present invention, the present invention provides a field-emission display comprising a hermetically sealed container accommodating: the non-evaporable getter for a field-emission display; and an electron-emitting device for emitting an electron by an electric field.

According to a still further aspect of the present invention, the present invention provides a method of manufacturing a non-evaporable getter for a field-emission display comprising steps of: forming a first layer containing titanium; and stacking, on the first layer, a second layer containing zirconium crystals of which average value of crystalline grain sizes is 3-20 nm.

The present invention can realize a getter suitable for removing a plural types of gases from the inside of an airtight container constituting an FED.

Further features of the present invention will become apparent from the following description of exemplary embodiments with reference to the attached drawings.

### BRIEF DESCRIPTION OF THE DRAWINGS

FIGS. 1A and 1B are graphs illustrating a relation between an absorbed quantity and an absorbing speed of a non-evaporable getter in one embodiment of the present invention.

FIGS. 2A and 2B are views illustrating a relation between an absorbing performance and the crystallinity of a getter having a Zr layer film-formed on the Ti layer, of which the crystallinity is different.

FIG. 3 is a view illustrating the dependency of absorbing characteristics for CO gas on the film thickness of a Zr layer, in a non-evaporable getter in one embodiment of the present invention.

FIG. 4 is a view illustrating a structure of an FED in one embodiment of the present invention.

FIG. 5 is a schematic view of an experimental apparatus which is used for measuring absorbing characteristics, and conducts a throughput method.

FIGS. 6A, 6B and 6C are graphs of absorbing characteristics of a getter, which are measured with a throughput method.

FIG. 7 is a graph illustrating a result of having measured absorbing characteristics for H₂O gas of non-evaporable getters of Exemplary Embodiment 1 and Comparative Examples 1-1 and 1-2.

FIGS. 8A, 8B and 8C are graphs illustrating the result of having measured the crystallinity of non-evaporable getters of Exemplary Embodiment 2 and Comparative Examples 2-1 and 2-2 with an XRD, and illustrating a relation between the crystallinity and the absorbing characteristics of the non-evaporable getter.

FIG. 9 is a graph illustrating a relation between the film thickness of the Zr layer and an absorbing speed in the middle stage of absorption, in non-evaporable getters of Exemplary Embodiments 3 to 5 and Comparative Examples 3-1 and 3-2.

### DESCRIPTION OF THE EMBODIMENTS

Preferred embodiments of the present invention will now be described in detail in accordance with the accompanying drawings.

Firstly, an embodiment of the non-evaporable getter according to the present invention will now be described. The non-evaporable getter according to the present invention is used as a getter for a field-emission display. The non-evaporable getter has a first layer (Ti layer) containing titanium, and a second layer (Zr layer) containing crystalline zirconium layered on the first layer. An average value of crystalline grain sizes of the crystalline zirconium in the second layer is 3 nm or more and 20 nm or less. Thus, the non-evaporable getter has a layered structure of the Ti layer and Zr layer.

The non-evaporable getter is manufactured by a method having steps of: forming a first layer containing titanium; and stacking, on the first layer, a second layer containing crystalline zirconium of which the average value of the crystalline grain sizes is 3 nm or more and 20 nm or less.

Ti which constitutes the first layer and Zr which constitutes the second layer are formed by the deposition of vaporized materials. Such a vapor-deposition method includes a method of heating the material, and a method of using physical energy as a sputtering method. Specifically, an electron beam vapor-deposition method, a jet printing method, a sputtering method or the like can be used.

One specific example includes film-forming the Ti layer on a glass substrate with the sputtering method, and subsequently forming the Zr layer on the Ti layer with the sputtering method to form the non-evaporable getter. Both of the Ti layer (lower layer) and the Zr layer (upper layer) have many gaps, and have a polycrystalline structure with a large specific surface area. Thereby, both of the Ti layer and the Zr layer can function as a getter which absorbs gas molecules (gas atoms).

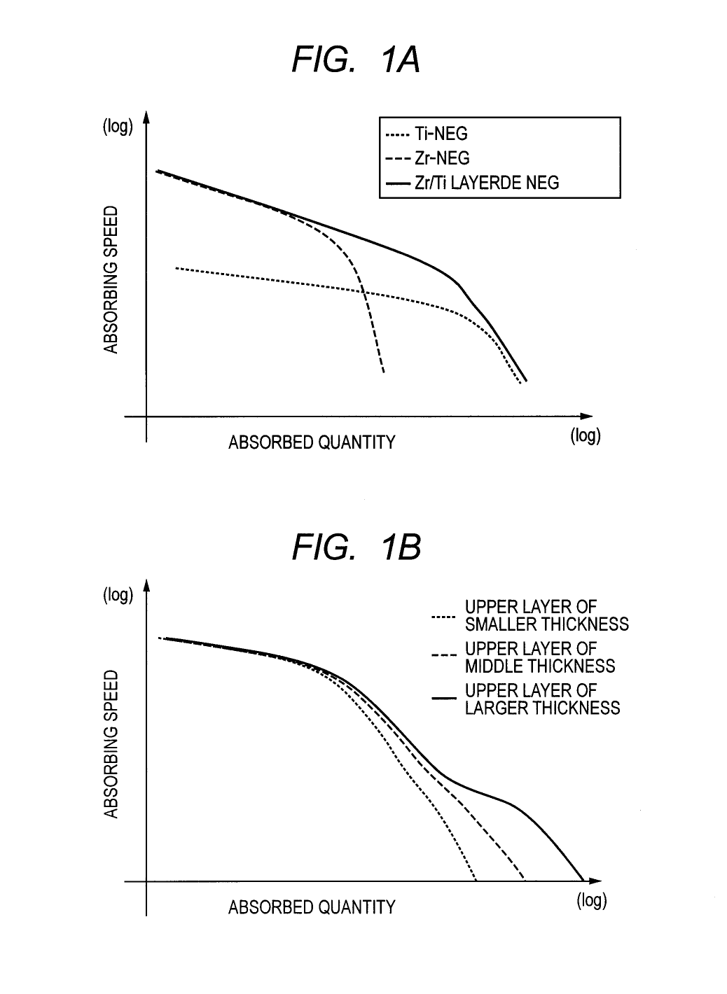

FIGS. 1A and 1B illustrate a result of having measured the performance (absorbing characteristics for gas per unit area) of the non-evaporable getter in which the Zr layer is layered on the Ti layer. For information, both of an ordinate axis and an abscissa axis are shown in a form of a logarithmic axis.

The abscissa axis shows the quantity of gases (absorbed quantity) which have been absorbed by a certain time point after the non-evaporable getter has been activated, and the ordinate axis shows the absorbing speed for the gases per unit time at the time. Hereafter, the total quantity of the gas which has been absorbed by the time when the absorbing speed becomes zero is defined as “total absorbed quantity.”

Referring to FIG. 1A, it is understood that the non-evaporable getter (solid line) according to the present embodiment has a performance approximately equal to that of a Zr getter (dashed line) of a monolayer, about an initial absorbing speed; and about the total absorbed quantity, it is shown that the non-evaporable getter has the performance of having summed those of the Zr getter of the monolayer and a Ti getter (dotted line) of a monolayer. Almost similar results to such a result are obtained for an arbitrary gas molecule of H₂O gas, CO gas or the like.

FIG. 1B illustrates absorbing characteristics for H₂O gas when the film thickness of the Zr layer (upper layer) has been changed. The initial absorbing speed almost does not depend on the film thickness of the Zr layer. In addition, as for the total absorbed quantity, the non-evaporable getter shows the characteristics of having summed the total absorbed quantity of the Zr getter of the monolayer and the total absorbed quantity of the Ti getter of the monolayer.

For the present, the present inventor considers the reason why the layered type non-evaporable getter of the present embodiment shows such absorbing characteristics, in the following way. The non-evaporable getter has an active metal surface which works as an absorption site, and absorbs the gas molecule and combines with the gas molecule. When the getter is hot, the combined gas molecule diffuses into the inner part of the getter. Then, the absorption site on the surface of the getter becomes active again. However, when the getter is in an environment of a low temperature such as room temperature, for instance, the diffusion does not almost occur, and the absorption site which has absorbed the gas becomes inactive and results in not contributing to the gas absorption after the time point.

As described above, by heating the non-evaporable getter which has absorbed the gas molecule in a vacuum or an inactive gas, the gas molecule combined with the getter in the vicinity of the surface diffuses into the inner part of the getter, and the non-evaporable getter develops the gas-absorption capability again (activation). In the getter right after having been activated, almost all the absorption sites in the vicinity of the surface of the getter are active. Therefore, the absorption sites on the outermost surface having a large probability of colliding with the gas molecule dominate the performance of the getter. When the absorption progresses, many of the absorption sites on the outermost surface of the getter become inactive. However, the inner part of the getter absorbs little amount of the gas molecule because of having a small probability of colliding with the gas molecule, and does not lose the absorbing performance so much. For this reason, as the absorption progresses, the characteristics in the absorption site in the inner part of the getter dominate the absorbing performance of the getter. In the non-evaporable getter according to the present invention, a layer existing on the outermost surface is the Zr layer. Therefore, the initial absorbing speed has a performance approximately equal to that of the Zr getter of a monolayer. In addition, Zr and Ti exist in the inner part of the getter layer, both of them work as a getter, and accordingly the total absorbed quantity has the performance of having summed those of the Zr getter of the monolayer and the Ti getter of the monolayer.

The Zr getter of the monolayer has high absorption capability for H₂O gas, and the Ti getter of the monolayer has high absorption capability for CO gas. Accordingly, the non-evaporable getter according to the present embodiment has high absorption capability for the H₂O gas when activation has started, and can keep the absorption capability for the CO gas for a long period of time, even when the absorption has progressed. Thereby, the non-evaporable getter can remove desorption gases, remaining gases and the like which exist in the inner part of an airtight container which constitutes the FED.

In the getter for the FED according to the present invention, the Zr layer and the Ti layer can contain many gaps and have a polycrystalline structure with a large specific surface area. This is because the gas molecule can easily ingress into the getter layer and such a total absorbed quantity can be obtained as to have summed the total absorbed quantities of each getter.

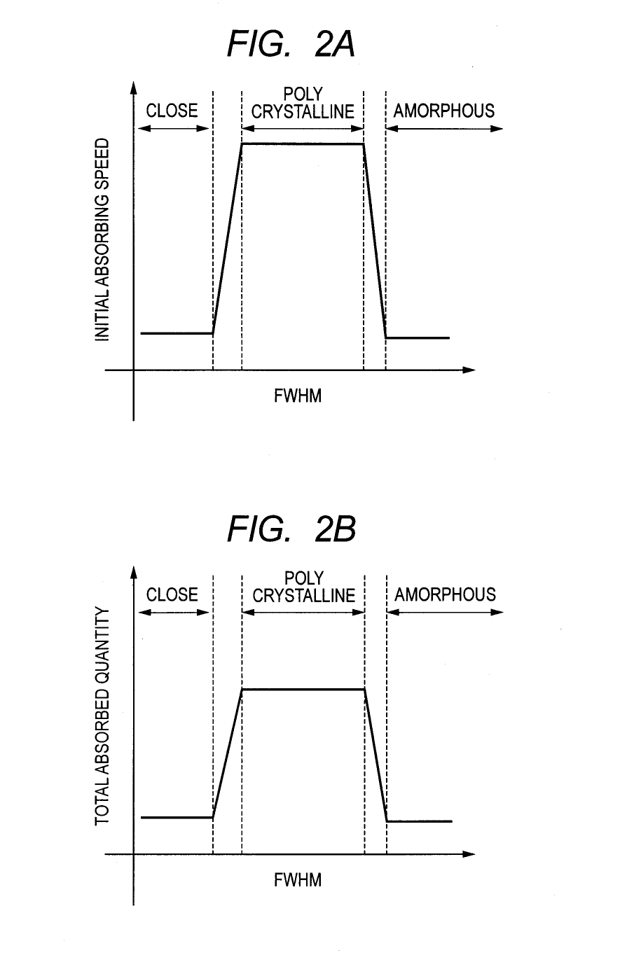

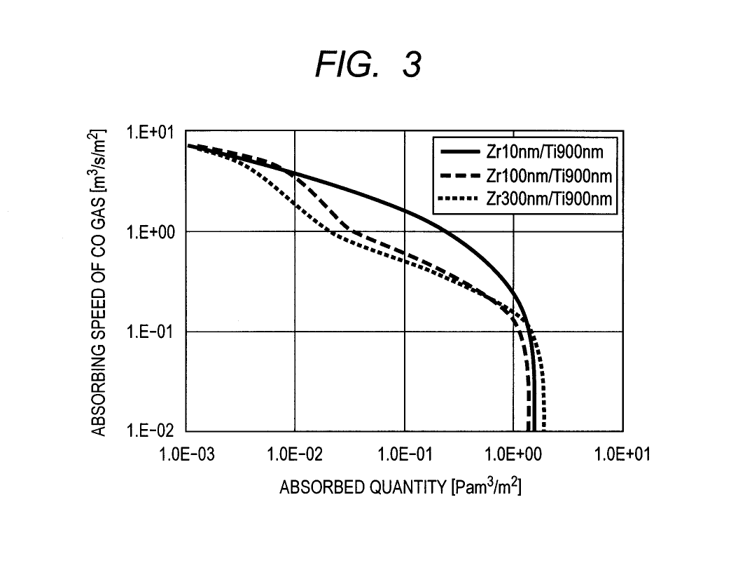

FIGS. 2A and 2B are graphs illustrating a relation between an absorbing performance and the crystallinity of a getter having a Zr layer film-formed on a polycrystalline Ti layer, of which the crystallinity is different. The FULL WIDTH AT HALF MAXIMUM (hereinafter referred to as “FWHM”) of a diffraction peak in an X-ray diffraction analysis (XRD analysis) can be used as a measure of the crystallinity of the Zr layer. It is known that when the FWHM is sufficiently small, the crystallinity is high and the Zr layer is in a close state, and that when the FWHM is sufficiently large, the crystallinity is low and the Zr layer is in an amorphous state.

FIG. 2A is a graph illustrating a relation between an absorbing speed (initial absorbing speed) and the crystallinity in the early stage of activation, and FIG. 2B is a graph illustrating a relation between the total absorbed quantity and the crystallinity. In FIG. 2A, in a state of a close film having a small FWHM of the diffraction peak and in a state of an amorphous film having a large FWHM, the initial absorbing speed is small. This shows that the specific surface area of the Zr layer is small in the state of the close film and the state of the amorphous film compared to the state of a polycrystalline film, and the performance of the Zr layer as the getter is small. In FIG. 2B as well similarly to FIG. 2A, when the film is in the state of the close film having a small FWHM or in the state of the amorphous film having a large FWHM, the total absorbed quantity is small. This means that the Zr layer of the upper layer has little gap, the gap of a Ti layer is covered with the Zr layer, and the absorption of gas molecules by the Ti layer can be suppressed.

As a result in the following Exemplary Embodiment 2 shows, the Zr layer can have the FWHM of a peak corresponding to a plane (100) in the XRD analysis in a range of 0.7° to 1.5°, which will be described later. In such a non-evaporable getter, both of the Zr layer and the Ti layer show absorbing characteristics, and gases in the inner part of an airtight container constituting the FED can be sufficiently removed.

In order to obtain a layered film in which both of the Zr layer and the Ti layer can function as the getter, the crystalline grain size of the Zr crystal constituting the Zr layer of the upper layer becomes important. When the crystalline grain size is small, the Zr layer forms a close film and suppresses the ingression of the gas molecules into the Ti layer of the lower layer. In addition, when the crystalline grain size is large, the Zr crystal having a large size plugs the gaps formed in the Ti layer, and suppresses the ingression of the gas molecules into the gaps. Therefore, in order to obtain a getter having a layered structure in which both of the Zr layer and the Ti layer can function as the getter, there can exist a range for the crystalline grain size of the Zr crystal constituting the Zr layer. In the present embodiment, the average value of the crystalline grain sizes of titanium is determined to be 3 nm or more and 20 nm or less, from such a viewpoint.

As is known, the crystalline grain size is determined from the XRD measurement result by using the expression of Scherrer “D=Kλ/β cos θ”. When the FWHM obtained by the XRD measurement is in a range of 0.7° to 1.5°, the average value of the crystalline grain sizes in a [100] direction is estimated to be 5 nm or more and 15 nm or less. The average value D of the crystalline grain sizes, a Scherrer constant K, the wavelength λ of X-rays, the FWHM β of the peak in the XRD measurement and the diffraction angle θ of the peak in the XRD measurement are defined. Here, X′Pert PRO MRD made by PANalytical B.V. was used for the XRD measurement. In the present specification, the wavelength λ of X-rays used for the measurement is 1.5 Å. In addition, a value 0.9 was used as the Scherrer constant K, and a value 35° was used as the diffraction angle θ of the peak.

In the actual crystal, the crystalline grain sizes may be slightly different according to the direction, and “K” in the expression of Scherrer may have a range of 0.9±0.3, in consideration of a coefficient which depends on a measuring instrument, and the like. Accordingly, the Zr layer having the average value of the crystalline grain sizes in a range of 3 nm or more and 20 nm or less is included in the present invention. Even in this case as well, the Zr layer does not exert an influence upon the effect of the present invention.

In the present embodiment, the crystalline grain sizes of all Zr crystals constituting a second layer do not need to be 3 nm or more and 20 nm or less, and the average value of the crystalline grain sizes of the Zr crystals may be 3 nm or more and 20 nm or less. This is because even in this case as well, the Zr layer sufficiently includes crystals having sizes of 3 nm or more and 20 nm or less and sufficiently functions as the getter.

In addition, even when the average value of the crystalline grain sizes of the Zr crystals in an arbitrary axial direction is 3 nm to 20 nm, or the average value of the crystalline grain sizes in a specific axial direction is 3 nm to 20 nm, the Zr layer sufficiently shows the function as the getter.

FIG. 3 is a graph illustrating an influence of the film thickness of the Zr layer on absorbing characteristics for CO gas when the film thickness has been changed. Here, the film thickness of the Ti layer was set at 900 nm. Similarly to the case illustrated in FIGS. 1A and 1B, an initial absorbing speed almost does not depend on the film thickness of the Zr layer. In addition, as for the total absorbed quantity, the layered structure has a total absorbed quantity of having summed those of a Zr getter of a monolayer and a Ti getter of a monolayer.

However, as is illustrated in FIG. 3, as the film thickness of the Zr layer increases, the absorbing speed in the middle stage of absorption decreases, which is different from the case of FIGS. 1A and 1B. For the present, the present inventor considers the reason why the layered structure shows such absorbing characteristics, in the following way.

As has been already discussed, the getter has a larger probability of colliding with gas in a region closer to the surface of the getter, and accordingly when the absorbed quantity is small, the absorbing characteristics in absorption sites in the vicinity of the surface exert a large influence upon the absorbing characteristics of the getter.

For the case of CO gas, it is known that the Ti layer shows larger absorbing characteristics than the Zr layer. Accordingly, the layered structure shows the absorbing characteristics which reflect characteristics of the Zr layer on the top surface in the early stage of activation, and an influence of the difference between the film thicknesses of the Zr layer is not almost observed. However, when the absorption proceeds, the smaller the film thickness of the Zr layer of the upper layer is, the more quickly the CO molecules are absorbed by the Ti layer, and the layered structure shows a high absorbing performance for the CO gas. On the contrary, in the getter having a large film thickness of the Zr layer, it takes time for the CO molecules to reach the absorption site of the Ti layer, and accordingly the absorbing speed in the middle stage of the absorption becomes small. This is the reason why the getter having the smaller film thickness of the Zr layer shows the higher absorbing speed, in the middle stage of the absorbing characteristics in FIG. 3.

Accordingly, in the present invention, an upper limit can be provided on the film thickness of the Zr layer. As a result in the following Table 3 shows, the film thickness of the Zr layer can be 1 μm or less in order that the getters of both the Zr layer and the Ti layer sufficiently show the absorbing performance, which will be described later.

The non-evaporable getter having a layered structure is disclosed also in Japanese Patent Application Laid-Open No. 2000-311588 and Japanese Patent Application Laid-Open No. 2005-000916. However, in Japanese Patent Application Laid-Open No. 2000-311588, the layered structure has Ti in the upper layer and a Zr alloy and the like in the lower layer. In such a structure, it is difficult to obtain a sufficiently high absorbing speed for absorbing H₂O gas released in the early stage of drive in the container of the FED. In contrast to this, in the present invention, the layered structure has a polycrystalline Zr layer arranged in the upper layer and the Ti layer arranged in the lower layer, and thereby can obtain a sufficiently high absorbing speed for absorbing the H₂O gas formed in the early stage of drive. Furthermore, because the Zr layer is polycrystalline, the gas molecules reach the Ti layer as well, the Ti layer functions as the getter, and thereby the layered structure can also sufficiently absorb CO gas released by the drive of the FED.

In addition, in Japanese Patent Application Laid-Open No. 2005-000916, the upper layer is amorphous. Accordingly, the ingression of the gas molecules into the lower layer is suppressed, which lowers the performance of the lower layer as the getter layer. In contrast to this, in the present invention, the Zr layer of the upper layer is polycrystalline, in other words, the average crystalline grain size is 3 nm or more and 20 nm or less, which can sufficiently make the Ti layer show the performance of the getter.

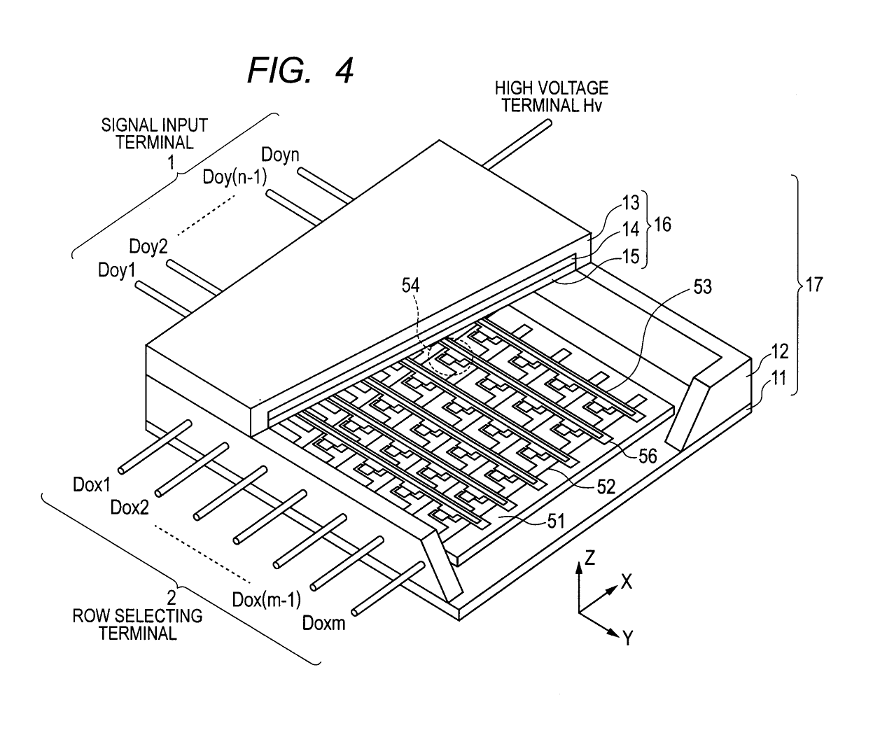

Next, the image display apparatus of the present invention will be described below. FIG. 4 is a schematic perspective view illustrating an image display apparatus, of which one part of the airtight container is ruptured so that the inner part of the airtight container can be viewed. The image display apparatus has the above described non-evaporable getter provided on the wires which connect each electron-emitting device 54 to others, on a substrate having a plurality of surface conduction electron-emitting devices 54 arranged thereon. A cold cathode device can be used as the electron-emitting device 54 which emits electrons by an electric field. Particularly, a surface conduction emitting device can be used as the electron-emitting device 54. This is because the non-evaporable getter according to the present invention can absorb H₂O gas and CO gas formed by the drive of the cold cathode device.

As for the array of the electron-emitting devices 54, various methods can be adopted, but there is a simple matrix arrangement as one example. The simple matrix arrangement is a method of arranging a plurality of the electron-emitting devices 54 in an X-direction and a Y-direction on a matrix. Then, one electrode of the plurality of the electron-emitting devices 54 arranged in the same row is commonly connected to a wire 52 in the X-direction. Furthermore, the other electrode of the plurality of the electron-emitting devices 54 arranged in the same column is commonly connected to a wire 53 in the Y-direction. An electron source substrate (which is referred to as a rear plate as well) 51 which has the electron-emitting devices 54 simply arranged on the matrix will be described below.

M lines of the wires 52 in the X-direction include Dox1, Dox2 and so on, to Doxm, and can be constituted by an electroconductive metal or the like (where m is a natural number). The material, the film thickness, the width and the film-forming method of the wires are appropriately designed. The wires 53 in the Y-direction include n lines of wires Doy1, Doy2 and so on, to Doyn, and are formed similarly to the wires 52 in the X-direction (where n is a natural number). An unshown interlayer insulation layer is provided in between the m lines of the wires 52 in the X-direction and the n lines of the wires 53 in the Y-direction to electrically separate the both lines from the other. The wires 52 in the X-direction are drawn out as a row selecting terminal (external terminal) 2, and the wires 53 in the Y-direction are drawn out as a signal input terminal (external terminal) 1.

A pair of electrodes (not shown) constituting the electron-emitting device 54 are electrically connected by connecting lines including the m lines of the wires 52 in the X-direction, the n lines of the wires 53 in the Y-direction, an electroconductive metal and the like.

An unshown scanning-signal-applying unit is connected to the wires 52 in the X-direction, which applies a scanning signal for selecting a row of the electron-emitting devices 54 that have been arrayed in the X-direction. On the other hand, an unshown scanning-signal-applying unit is connected to the wires 53 in the Y-direction, which applies a scanning signal for selecting each column of the electron-emitting devices 54 that have been arrayed in the Y-direction. A driving voltage to be applied to each of the electron-emitting devices 54 is supplied in a form of a potential difference between the scanning signal and the modulation signal to be applied to the electron-emitting devices 54. The image display apparatus having the above described configuration can select an individual electron-emitting device 54 and independently drive every electron-emitting device 54 by using the simple matrix wiring.

The electron source substrate 51 constitutes the electron-emitting device 54 and the airtight container (envelope) 17 which accommodates the non-evaporable getter according to the present invention therein, together with a supporting frame 12 and a face plate 16. When the airtight container 17 has insufficient strength, a reinforcing plate 11 may also be attached to the electron source substrate 51. In this case, the electron source substrate 51 combined with the reinforcing plate 11 is occasionally referred to as a rear plate. The face plate 16 has a fluorescent film 14, a metal back 15 and the like formed on the inner surface of a glass substrate 13. The rear plate 51 and the face plate 16 are bonded to the supporting frame 12 by using a solder having a low melting point, a frit glass and the like.

The envelope 17 is adapted by the face plate 16, the supporting frame 12, the rear plate 51 and the like, as was described above. An unshown support member referred to as a spacer may also be provided between the face plate 16 and the rear plate 51. Thereby, the envelope 17 can be also structured so as to have a sufficient strength against atmospheric pressure.

The image display apparatus provided with the non-evaporable getter according to the present invention is produced in the following way, as one example. A non-evaporable getter 56 is film-formed on the wires 53 in the Y-direction, which is prepared by film-forming a non-evaporable getter (second layer) containing Zr on a non-evaporable getter (first layer) containing Ti. Specifically, firstly, the non-evaporable getter containing Ti is film-formed. Then, the non-evaporable getter containing Zr is film-formed on the Ti layer. A usable film-forming method includes an arbitrary film-forming method which can form a film for the Ti layer or the Zr layer, such as a plasma spray method, an electron beam vacuum-deposition method, a sputtering technique and a resistance heating technique. However, such a method that the average value of the crystalline grain sizes of Zr crystals is 3 nm to 20 nm is selected as a method for film-forming the Zr layer.

In order to prevent the destruction of the wires of the FED, the electrical continuity of the electrode and a device-forming member, these members can be masked by using a photosensitive material, a metal mask or the like, and then the Ti layer and the Zr layer can be film-formed. Alternatively, in some cases, the Ti layer and the Zr layer are film-formed, and a film in an unnecessary portion is removed by using an etching technique.

In addition, the non-evaporable getter according to the present invention may also be arranged on the wires 52 in the X-direction as well as on the wires 53 in the Y-direction or solely. In the case, a mask having an aperture provided in the portion corresponding to the wires in the X-direction is formed, and the non-evaporable getter is film-formed. Alternatively, the wires 52 in the X-direction are protected, and other portions may also be etched.

In order to enhance the electroconductivity of the fluorescent film 14, a transparent electrode (not-shown) may also be provided in the outer surface side of the fluorescent film 14 in the face plate 16.

One example of a method of manufacturing an FED according to one embodiment of the present invention will be described below. An electron source substrate (rear plate) 51 provided with a plurality of electron-emitting devices 54 is produced by forming electrodes and wiring patterns 52 and 53 on a glass substrate and arranging the electron-emitting devices 54 therein, with various combined methods of a printing method, a photolithographic method and the like. A non-evaporable getter 56 is formed on matrix wires 52 and 53 of the produced electron source substrate 51, for instance, with a vacuum vapor-deposition method (sputtering method).

The non-evaporable getter 56 may be formed after the electron source substrate 51 has been produced, or may also be formed while the electron source substrate 51 is being produced or before the electron source substrate 51 is produced. In addition, the Zr layer may also be formed while the substrate is held in the vacuum or in the inert gas, after the Ti layer has been formed in a vacuum or in an inert gas. Alternatively, after the Ti layer has been formed, the substrate is exposed to the atmosphere, and then the Zr layer may also be formed. It is also acceptable to form the Ti layer, then form films for constituting other members in the FED, form a photoresist, etch the film, and then form the Zr layer.

On the other hand, a face plate 16 is produced by arranging an image-forming member, such as a fluorophor, on another glass substrate. An envelope 17 is formed of a rear plate 51, a supporting frame 12 and the face plate 16. Before the envelope 17 is formed, each member needs to be degassed. At this time, the non-evaporable getter 56 is activated and shows its absorption capability. Members 51, and 16 constituting the envelope 17 can be bonded to each other in a vacuum or in an inert gas by using a solder. Thereby, the envelope 17 is formed. The solder can be heated by heating the supporting frame 12 with the use of energization or a high-frequency electric power.

In the present example, the non-evaporable getter 56 was formed on the wire 53 in an image display region. However, the non-evaporable getter may also be formed on other electrodes in the image display region, in a gap between the wires, or in the periphery of the image display region outside the image display region and in the vicinity of the supporting frame 12, further on the surface of the supporting frame 12 or on the face plate 16.

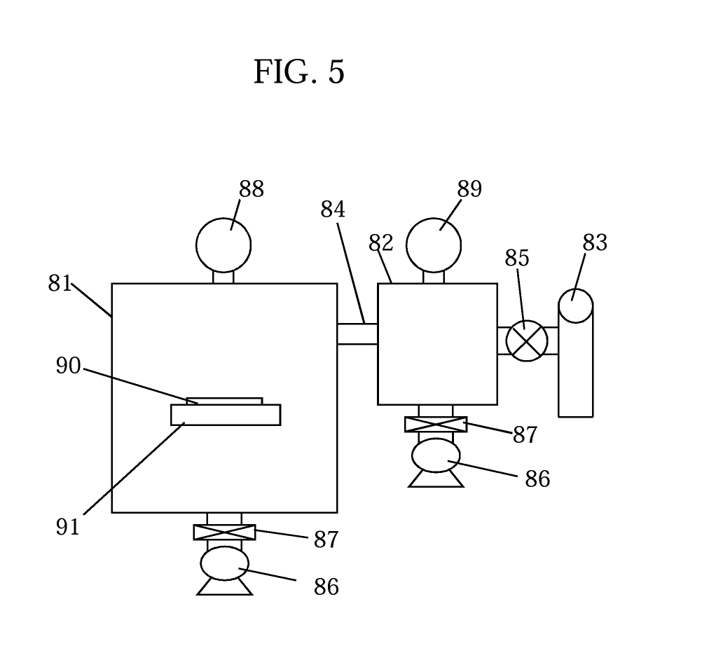

Exemplary embodiments of the present invention will be described below. Firstly, a throughput method used for measuring the absorption capability of the non-evaporable getter will be described below. FIG. 5 is a schematic view of an apparatus used for measuring the absorption capability of the non-evaporable getter by using a throughput method. This apparatus has a measurement chamber 81, a gas introduction chamber 82 and a gas cylinder 83. The measurement chamber 81 is connected with the gas introduction chamber 82 by a pipe 84 having a known conductance. Here, the conductance of this pipe 84 is represented by C, for convenience. The gas cylinder 83 is filled with a gas for measuring the absorption capability of the non-evaporable getter. The gas cylinder 83 is connected to the gas introduction chamber 82 by using a variable leak valve 85 and the like so that the quantity of the gas to be introduced can be controlled.

An exhaust device 86 is attached to the measurement chamber 81 and the gas introduction chamber 82, and is structured so as to be capable of exhausting the air in the inside of the respective chambers 81 and 82 to form a vacuum state. Gate valves 87 are installed between the exhaust devices 86 and the respective chambers 81 and 82. Vacuum gages 88 and 89 which can measure the gas pressures in the chambers 81 and 82 are attached to the measurement chamber 81 and the gas introduction chamber 82, respectively. Here, the gas pressure shown by the vacuum gage 88 attached to the measurement chamber 81 is represented by P1, and the gas pressure shown by the vacuum gage 89 attached to the gas introduction chamber 82 is represented by P2, for convenience.

A substrate holder 91 for holding a getter substrate 90 is installed in the measurement chamber 81. In the present example, a heater is attached to the substrate holder 91, and is structured so as to be capable of activating the non-evaporable getter by heating the getter substrate 90.

An actual measurement procedure will be described below. In a state in which the getter substrate 90 is installed in the measurement chamber 81, the measurement chamber 81 and the gas introduction chamber 82 are sufficiently evacuated. This is conducted in order to prevent remaining gases from mixing into the gas for measurement or the non-evaporable getter from absorbing the remaining gases during the activation period and being deteriorated. When the measurement chamber 81 and the gas introduction chamber 82 have been sufficiently evacuated, the getter substrate 90 is heated by using the heater of the substrate holder 91 and the non-evaporable getter is activated. When the non-evaporable getter has been activated and shows its absorption capability, a gate valve 87 is closed, and the measurement chamber 81 and the gas introduction chamber 82 are made to be airtight. Then, the variable leak valve 85 of the gas cylinder 83 is operated, and the gas for measurement is introduced into the gas introduction chamber 82 and the measurement chamber 81.

At this time, the gas which has been introduced from the gas cylinder 83 enters the measurement chamber 81 through the pipe 84 from the gas introduction chamber 82, and is absorbed by the non-evaporable getter on the getter substrate 90. The quantity Q of the gas which passes through the pipe 84 is given to be “Q=C (P2-P1)” from the definition of the conductance. At this time, a direction in which the gas enters the measurement chamber 81 from the gas introduction chamber 82 was defined to be a positive direction.

In this case, because the gate valves 87 between the exhaust devices 86 and the respective chambers 81 and 82 are closed, the gas which has entered the measurement chamber 81 through the pipe 84 from the gas introduction chamber 82 is absorbed by the non-evaporable getter on the getter substrate 90. Accordingly, by measuring the gas pressures P1 and P2 indicated by the vacuum gages 88 and 89 and by calculating the flow velocity and the flow rate of the gas which passes through the pipe 84, the absorbing speed of and the total absorbed quantity by the non-evaporable getter can be measured.

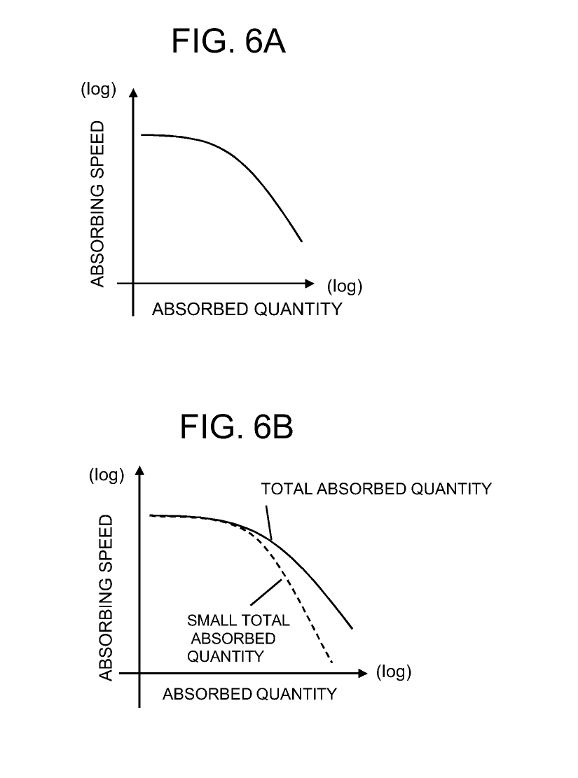

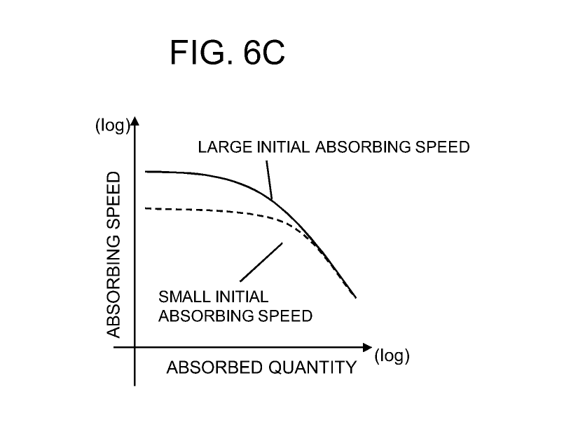

FIGS. 6A to 6C illustrate one example of a measurement result. An abscissa axis shows the quantity of a gas absorbed by the non-evaporable getter by a certain time, and an ordinate axis shows an absorbing speed at the time point. As is illustrated in FIG. 6A, as the quantity of the absorbing gas increases, the absorbing speed decreases. This is because when gas molecules are absorbed to an absorption site, the number of active absorption sites decreases. For information, a similar graph to that in FIG. 6A is obtained not only for a specific type of gas but also for a general type of gas. FIG. 6B illustrates one example of absorbing characteristics of getters which have different total absorbed quantities, though having the same initial absorbing speed, and FIG. 6C illustrates one example of absorbing characteristics of getters which have different initial absorbing speeds, though having the same total absorbed quantity.

Hereafter, the total absorbed quantity of CO gas will be specified by the absorbed quantity when the absorbing speed has reached 10⁻² [/s/m²], for convenience. The absorbing speed for CO gas in the early stage of the drive is specified by the absorbing speed when the absorbed quantity has reached 10⁻³ [Pam³/m²], for convenience. The total absorbed quantity of H₂O gas is specified by the absorbed quantity when the absorbing speed has reached 10⁻¹ [m³/s/m²], for convenience. Hereafter, the absorbing speed for H₂O gas in the early stage of the drive will be specified by the absorbing speed when the total absorbed quantity has reached 10⁻¹ [Pam³/m²], for convenience.

### Exemplary Embodiment 1

A Ti layer was film-formed on a glass substrate having the thickness of 1.8 mm with a sputtering method. Then, a Zr layer was subsequently film-formed on the Ti layer with the sputtering method, without exposing the Ti layer to the air. The film forming conditions are shown in the following Table 1.

### Comparative Example 1-1

Only a Ti layer was film-formed on a glass substrate having the thickness of 1.8 mm with a sputtering method. The film forming conditions are shown in the following Table 1.

### Comparative Example 1-2

Only a Zr layer was film-formed on a glass substrate having the thickness of 1.8 mm with a sputtering method. The film forming conditions are shown in Table 1.

TABLE 1

| | Ar | Power density | Film | Film |
|---|---|---|---|---|
| | pressure | applied to | thickness | thickness |
| | (Pa) | target (W/cm²) | of Zr (nm) | of Ti (nm) |
| Exemplary | 2 | 0.6 | 100 | 900 |
| embodiment 1 | | | | |
| Comparative | | | 0 | 900 |
| example 1-1 | | | | |
| Comparative | | | 100 | 0 |
| example 1-2 | | | | |

The getters produced in this way were subjected to activation treatment at 400° C. for 1 hour in the atmosphere of 10⁻³ Pa or less, respectively, were cooled to room temperature, and were then subjected to the measurement of the absorbing performance. The gas-absorbing performance was measured with a throughput method by using H₂O gas.

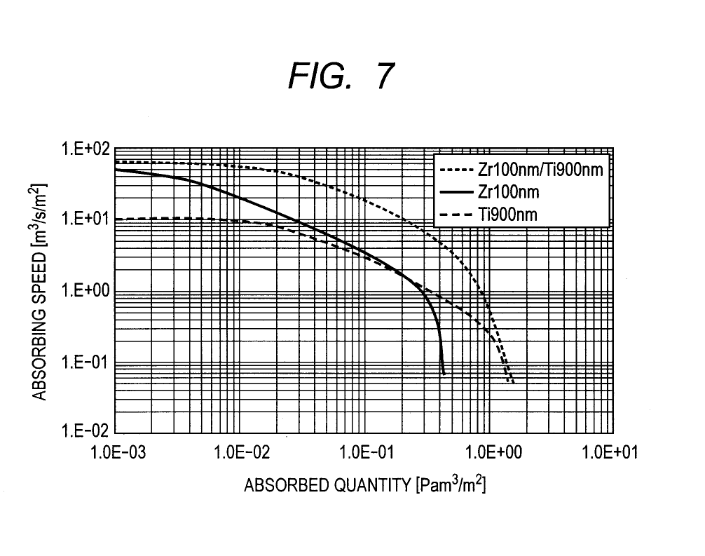

Three types of non-evaporable getters measured in this way showed absorbing performances as illustrated in FIG. 7. As described in the embodiment, the result shows that the Zr/Ti layered type getter in Exemplary Embodiment 1 has the performance equivalent to that of a Zr getter of a monolayer about an initial absorbing speed, and has the performance of having summed those of the Zr getter of the monolayer and a Ti getter of a monolayer about the total absorbed quantity.

### Exemplary Embodiment 2

A Ti layer was film-formed on a glass substrate having the thickness of 1.8 mm with a sputtering method. Then, a Zr layer was subsequently film-formed on the Ti layer with the sputtering method, without exposing the Ti layer to the air. The film forming conditions for the Zr layer were selected so that the Zr crystal was polycrystalline. The film forming conditions in Exemplary Embodiment 2 are shown in the following Table 2. As a result of a crystalline analysis by XRD of the produced non-evaporable getter, the FWHM of the peak corresponding to the plane (100) was 1.2°.

### Comparative Example 2-1

A Ti layer was film-formed on a glass substrate having the thickness of 1.8 mm with a sputtering method. Then, a Zr layer was subsequently film-formed on the Ti layer with the sputtering method, without exposing the Ti layer to the air. In the present example, a close Zr film was film-formed. The film forming conditions are shown in the following Table 2. As a result of the crystalline analysis by XRD of the produced Zr layer, the FWHM of the peak corresponding to the plane (100) was 0.6°.

### Comparative Example 2-2

A Ti layer was film-formed on a glass substrate having the thickness of 1.8 mm with a sputtering method. Then, a Zr layer was subsequently film-formed on the Ti layer with the sputtering method, without exposing the Ti layer to the air. In the present example, an amorphous Zr layer was film-formed by changing the film forming conditions of the Zr layer. The film forming conditions are shown in Table 2. As a result of the crystalline analysis by XRD of the produced Zr layer, the FWHM of the peak corresponding to the plane (100) was 1.7°.

TABLE 2

| | Ti layer | | | Zr layer | | | |
|---|---|---|---|---|---|---|---|
| | | Power | | | Power | | |
| | | density | | | density | | |
| | | applied | | | applied | | FWHM |
| | Ar | to | Film | Ar | to | Film | (degree) |
| | pressure | target | thickness | pressure | target | thickness | of XRD |
| | (Pa) | (W/cm²) | (nm) | (Pa) | (W/cm²) | (nm) | (degree) |
| Exemplary | 2 | 0.6 | 900 | 2 | 0.6 | 300 | 1.2 |
| embodiment | | | | | | | |
| 2 | | | | | | | |
| Comparative | | | | 0.5 | 1.3 | | 0.6 |
| example 2-1 | | | | | | | |
| Comparative | | | | 5 | 0.08 | | 1.7 |
| example 2-2 | | | | | | | |

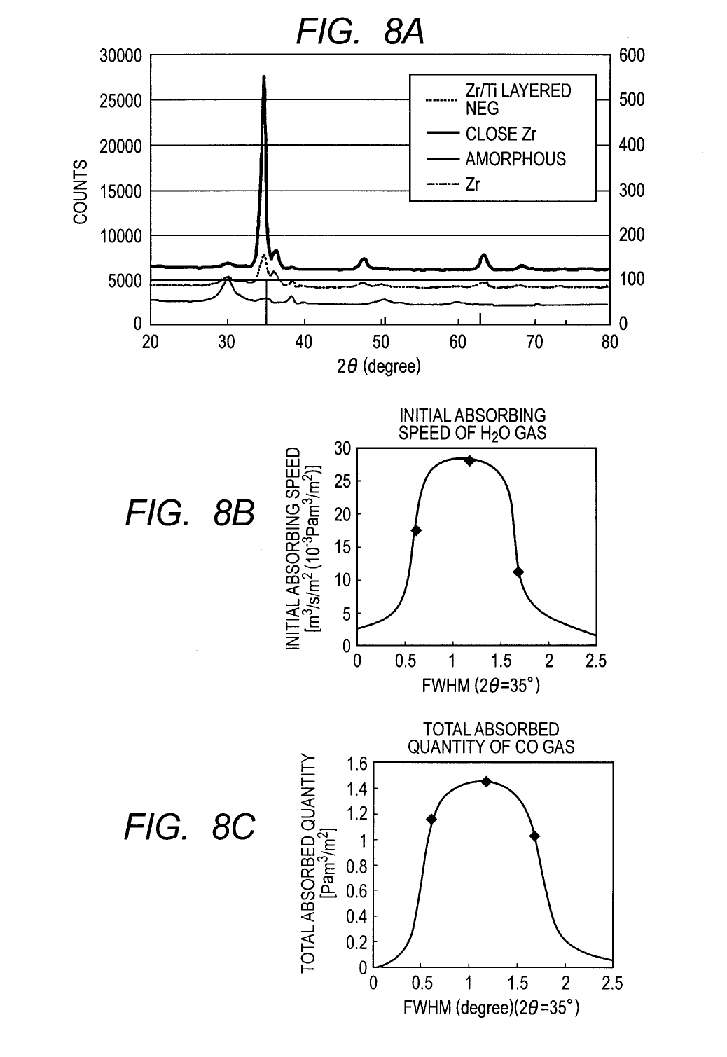

Three types of the non-evaporable getters produced in this way were subjected to activation treatment at 400° C. for 1 hour in the atmosphere of 10⁻³ Pa or less were cooled to room temperature, and were then subjected to the measurement of the absorbing performance. The absorbing performance for gas was measured with a throughput method by using CO gas and H₂O gas. These measurement results are illustrated in FIGS. 8A to 8C.

FIG. 8A is a result of having evaluated the crystallinities of the three types of the non-evaporable getters with an XRD analysis. The dotted line illustrates the result of Exemplary Embodiment 2, the thick solid line illustrates the result of Comparative Example 2-1, and the thin solid line illustrates the result of Comparative Example 2-2. FIG. 8B illustrates the relation between the absorbing speed in the early stage of the drive for H₂O gas and crystallinity, and FIG. 8C illustrates the relation between the total absorbed quantity of CO gas and crystallinity. As in Exemplary Embodiment 2, the non-evaporable getter which has arranged a polycrystalline Zr layer in the upper layer shows a high absorbing performance compared to those of Comparative Example 1 and Comparative Example 2.

In order to suppress the influence of gas in an envelope of an image display apparatus, the getter can have the absorbing speed in the early stage of the drive of 18 [m³/s/m²] or more for H₂O gas. For that purpose, the Zr layer according to the present invention can be the polycrystalline film in which the FWHM of the peak corresponding to the plane (100) of the Zr crystal obtained by an XRD analysis is in the range of 0.7° to 1.5°. In this case, as illustrated in FIG. 8C, the graph of the total absorbed quantity of CO gas implies that the non-evaporable getter has such a feature of the present invention that both of the Zr layer and the Ti layer develop the absorption capability.

### Exemplary Embodiment 3

A Ti layer was film-formed on a glass substrate having the thickness of 1.8 mm with a sputtering method.

Then, a Zr layer was subsequently film-formed on the Ti layer with the sputtering method, without exposing the Ti layer to the air. The film forming conditions for the Zr layer were selected so that a polycrystalline Zr layer was formed. The film forming conditions are shown in the following Table 3.

### Exemplary Embodiment 4

A Ti layer was film-formed on a glass substrate having the thickness of 1.8 mm with a sputtering method. Then, a Zr layer was subsequently film-formed on the Ti layer with the sputtering method, without exposing the Ti layer to the air. The film forming conditions for the Zr layer were selected so that a polycrystalline Zr layer was formed. The film forming conditions are shown in the following Table 3.

### Exemplary Embodiment 5

A Ti layer was film-formed on a glass substrate having the thickness of 1.8 mm with a sputtering method. Then, a Zr layer was subsequently film-formed on the Ti layer with the sputtering method, without exposing the Ti layer to the air. The film forming conditions for the Zr layer were selected so that a polycrystalline Zr layer was formed. The film forming conditions are shown in Table 3.

### Comparative Example 3-1

Only a Ti layer was film-formed (Ti mono film) on a glass substrate having the thickness of 1.8 mm with a sputtering method. The film forming conditions are shown in Table 3.

### Comparative Example 3-2

Only a Zr layer was film-formed on a glass substrate having the thickness of 1.8 mm with a sputtering method. The film forming conditions for the Zr layer were selected so that a polycrystalline Zr layer was formed (Zr mono film). The film forming conditions are shown in Table 3.

TABLE 3

| | Ti layer | | | Zr layer | | |
|---|---|---|---|---|---|---|
| | | Power | | | Power | |
| | | density | | | density | |
| | | applied | Film | | applied | Film |
| | Ar | to | thick- | Ar | to | thick- |
| | pressure | target | ness | pressure | target | ness |
| | (Pa) | (W/cm²) | (nm) | (Pa) | (W/cm²) | (nm) |
| Exemplary | 2 | 0.6 | 900 | 2 | 0.6 | 300 |
| embodiment | | | | | | |
| 3 | | | | | | |
| Exemplary | | | | | | 200 |
| embodiment | | | | | | |
| 4 | | | | | | |
| Exemplary | | | | | | 100 |
| embodiment | | | | | | |
| 5 | | | | | | |
| Comparative | | | 1000 | | | — |
| example 3-1 | | | | | | |
| Comparative | | | — | | | 1000 |
| example 3-2 | | | | | | |

Five types of the non-evaporable getters in Exemplary Embodiments 3 to 5 and Comparative Examples 3-1 and 3-2 were subjected to activation treatment at 400° C. for 1 hour in the atmosphere of 10⁻³ Pa or less, were cooled to room temperature, and were then subjected to the measurement of the absorbing performance. The gas-absorbing performance was measured with a throughput method by using CO gas.

Three types of the non-evaporable getters in Exemplary Embodiments 3 to 5 showed absorbing performances as illustrated in FIG. 3. As described in the embodiment as well, as the film thickness of the Zr layer of the upper layer increases, the absorbing speed in the middle stage of absorption decreases.

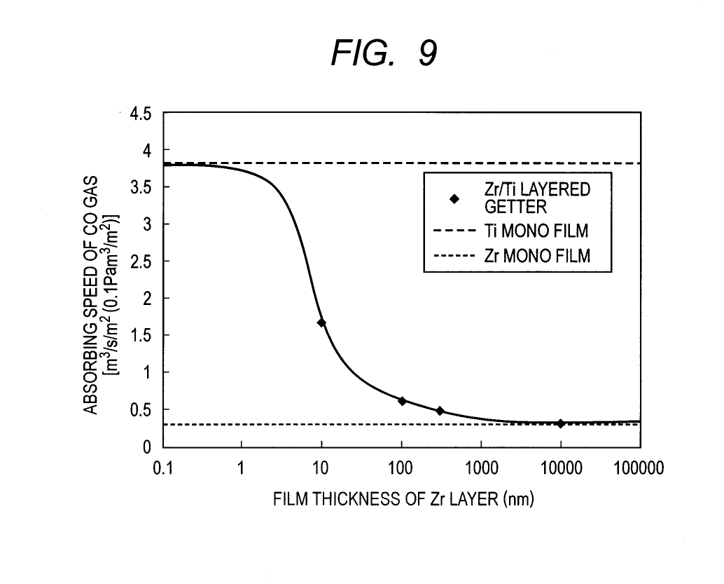

FIG. 9 is a graph which shows a relation between the absorbing speed at the time point when the total absorbed quantity is 0.1 [Pam³/m²], and the film thickness of a Zr layer. In FIG. 9, the absorbing characteristics of a Ti getter and a Zr getter in Comparative Example 3-1 and 3-2 are illustrated, in addition to the absorbing characteristics of the three types of the getters illustrated in FIG. 3. In the graph, the dashed line shows the result of the Ti getter (Comparative Example 3-1) of a monolayer, and the dotted line shows the result of the Zr getter (Comparative Example 3-2) of a monolayer. It is understood from the graph that in order to make the Ti getter of a monolayer and the Zr getter of a monolayer show both performances, the film thickness of the Zr layer can be 1 μm or less.

### Exemplary Embodiment 6

Next, one exemplary embodiment of an FED according to the present invention will be described below. The FED of the present exemplary embodiment has a structure similar to an apparatus schematically illustrated in FIG. 4, and forms an airtight container 17 by sealing an electron source substrate 51, a supporting frame 12 and a face plate 16. The electron source substrate 51 is provided with the electron source which has a plurality (1080 rows×5760 columns) of surface conduction electron-emitting devices 54 wired in a simple matrix form on the substrate. The used supporting frame 12 was a metal frame which was made from an alloy of iron and nickel and was plated with gold. The face plate 16 has a fluorescent film 14 and a metal back 15 formed on a glass substrate 13. The electron source substrate 51 has X-direction wires 52 (upper wiring) formed by photolithography, and the non-evaporable getters 56 are provided on the X-direction wires 52.

FIG. 4 is a schematic view illustrating one example of a display panel adapted by using an electron source having electron-emitting devices arranged in a matrix form, in which one part of the display panel is cut away so that the inner part can be grasped. In FIG. 4, the electron source substrate 51, the X-direction wires 52 and the Y-direction wires 53 are shown. In addition, the electron-emitting device 54 is schematically illustrated. Incidentally, the X-direction wires 52 are wires which commonly connect the cathode electrodes, and the Y-direction wires 53 are wires which commonly connect the gate electrodes. Here, the figure schematically illustrates an example in which the electron-emitting device 54 is arranged at an intersection of the X-direction wire 52 and the Y-direction wire 53, but the electron-emitting device can be arranged on the electron source substrate 51 in the vicinity of the intersection of the X-direction wire 52 and the Y-direction wire 53. The non-evaporable getter 56 is formed on the X-direction wire 52.

A method for manufacturing the non-evaporable getter according to the present exemplary embodiment will be described below with reference to FIG. 4.

(Step (a)) The X-direction wire 52 was formed by stacking a tantalum nitride film on a copper (Cu) film. The copper film was formed with an electric-field plating method, and the thickness was controlled to 19 μm. The copper film was patterned by using a wet etching method. The tantalum nitride film was formed by using a sputtering method, and the thickness was controlled to 100 nm. The tantalum nitride film was patterned by using a dry etching method.

(Step (b)) A photoresist was patterned so that an opening was formed in a region in which the X-direction wires produced in the step (a) existed. Subsequently, a Ti layer was formed by using a sputtering method. The thickness of the Ti layer was controlled to 900 nm. Then, a Zr layer was subsequently formed on the Ti layer by using a sputtering method. The thickness of the Zr layer was controlled to 300 nm. The photoresist pattern was dissolved by an organic solvent, the Zr/Ti layered film was lifted off, and the non-evaporable getter 56 was formed on the X-direction wires 52.

(Step (c)) The electron source substrate 51, the face plate 16 and the supporting frame 12 were heated in an apparatus in which the inner part was kept at a vacuum. The electron source substrate 51 and the supporting frame 12 were heated at 400° C. for 1 hour under a vacuum of about 10⁻⁵ Pa, and the face plate 16 was heated at 450° C. for 1 hour under a vacuum of about 10⁻⁵ Pa. By this step, each member is degassed, and at the same time the non-evaporable getter is activated to result in showing its absorbing performance.

(Step (d)) The electron source substrate 51 and the face plate 16 are opposed so as to sandwich the supporting frame 12, and are sealed to each other. The electron source substrate 51 and the supporting frame 12, and the face plate 16 and the supporting frame 12 were respectively bonded to each other by using a metal solder.

Thus, the FED provided with an airtight container 17 is manufactured in which the non-evaporable getter 56 according to the present invention and the electron-emitting device 54 have been accommodated.

### Comparative Example 4

An FED was manufactured according to the steps (a), (c) and (d) shown in Exemplary Embodiment 6. The FED of Comparative Example 4 has the same structure as the FED of Exemplary Embodiment 6 except that the FED of Comparative Example 4 does not have a non-evaporable getter on the X-direction wires.

The FEDs of Exemplary Embodiment 6 and Comparative Example 4 were driven, and a variation with time of luminance was measured. As a result of the measurement, the attenuation with time of the luminance of the FED of Exemplary Embodiment 6 was clearly smaller than the attenuation with time of the luminance of the FED of Comparative Example 4, and it was confirmed that the non-evaporable getter had an effect of suppressing the degradation of the luminance of the FED.

### INDUSTRIAL APPLICABILITY

A non-evaporable getter according to the present invention can be used for removing gas in a vacuum airtight container, and is useful particularly for removing gas in the inner part of an envelope used for an FED.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-072952, filed Mar. 26, 2010, which is hereby incorporated by reference herein in its entirety.

What is claimed is:

1. A non-evaporable getter for a field-emission display comprising:
a first layer containing titanium; and
a second layer containing crystalline zirconium layered on the first layer, wherein
an average value of crystalline grain sizes of the crystalline zirconium is 3-20 nm.

2. The non-evaporable getter for a field-emission display according to claim 1, wherein
the second layer forms, according to an X-ray diffraction analysis, a FULL WIDTH AT HALF MAXIMUM in a range of 0.7-1.5 degrees at a plane (100) of the crystalline zirconium.

3. The non-evaporable getter for a field-emission display according to claim 1, wherein
the second layer has a film thickness of 1 μm or smaller.

4. A field-emission display comprising a hermetically sealed container accommodating:
the non-evaporable getter for a field-emission display according to claim 1; and
an electron-emitting device for emitting an electron by an electric field.

5. A method of manufacturing a non-evaporable getter for a field-emission display comprising steps of:
forming a first layer containing titanium; and
stacking, on the first layer, a second layer containing zirconium crystals of which average value of crystalline grain sizes is 3-20 nm.
